(19) United States
(12) Patent Application Publication
(10) Pub. No.: US 2003/0172213 A1
(43) Pub. Date: Sep. 11, 2003

(54) Artificially intelligent arbitration system and process for optimizing multiple processes sharing a resource

(76) Inventors: Enrique Garcia, Tucson, AZ (US); Yvonne Kleppel, Tucson, AZ (US); Rajendrasinh Jadeja, Tucson, AZ (US); Robert Earl Medlin, Tucson, AZ (US); Russell Lee Ellison, Corona deTucson, AZ (US); Gregg Steven Lucas, Tucson, AZ (US)

Correspondence Address: Edmund P. Pfleger, Grossman, Tucker, Perreault & Pfleger, PLLC, 55 South Commerical Street, Manchester, NH, 03101, US

(21) Appl. No.: 10/091,796

(22) Filed: Mar. 6, 2002

(51) Int. Cl. G06F 13/36

(52) U.S. Cl. 710/113

(57) ABSTRACT

An arbitration system and process is provided to arbitrate usage of a shared resource. The system and process dynamically adjust to changing workloads and includes artificial intelligence to learn from experience how to optimize system throughput. In system form, the present invention provides a resource arbitration system that includes an arbitration controller adapted to monitor a resource used by a plurality of agents and adapted to calculate an optimal usage of said resource for each agent. The controller also generates grant control signals to each agent to couple agents to the resource based on the calculated optimal usage for each agent.

### 1. FIELD OF THE INVENTION

The present invention relates to an arbitration process for optimized usage of a shared resource. More particularly, the present invention relates to an artificially intelligent scheme to arbitrate usage of a shared resource by dynamically adjusting to changing workloads to optimize system throughput. Particular utility can be found in digital systems where there is a need to arbitrate usage of a shared resource, although other utilities well outside this scope are equally contemplated herein.

### 2. BACKGROUND OF THE INVENTION

Often in digital systems, as well as numerous other processes, there arises a need to arbitrate usage of a shared resource. One example is the arbitration required to allow multiple agents to share a PCI bus in a typical computer workstation. In this context, many arbitration schemes are known. For example, a simple “round robin” approach may be used. In this approach the bandwidth (bytes/time) allocated to each is done democratically, i.e., each agent gets an equal slice of the bandwidth. Another approach is to use various priority encoding schemes where each agent is assigned, a priori, a priority relative to other agents, for example, even, high or low priority. Each of these arbitration schemes, however, lacks the ability to dynamically adjust to changing workloads. Moreover, none of these arbitration schemes has the ability to learn from experience how to optimize system throughput.

### SUMMARY OF THE INVENTION

Accordingly, the present invention provides an arbitration system and process that includes artificial intelligence to optimize multiple agents sharing a resource.

In one aspect, the present invention provides a resource arbitration system, comprising a plurality of agents selectively coupled to a resource. An arbitration controller is provided to monitor the resource used by each agent, and further adapted to calculate an optimal usage of the resource for each agent. The controller generates grant control signals to each agent to couple the agents to the resource based on the calculated optimal usage for each agent.

In another aspect, the present invention provides a resource arbitration process comprising the steps of fixing an arbitration for a plurality of agents sharing a resource; determining the demand for each agent by skewing arbitration priority to the particular agent; correlating the demands for each agent for a predetermined duration; and assigning resource arbitration priority to each agent based on the historical ratio of the demand for each agent over the sum of the demands of all agents.

It will be appreciated by those skilled in the art that although the following Detailed Description will proceed with reference being made to preferred embodiments and methods of use, the present invention is not intended to be limited to these preferred embodiments and methods of use. Rather, the present invention is of broad scope and is intended to be limited as only set forth in the accompanying claims.

Other features and advantages of the present invention will become apparent as the following Detailed Description proceeds, and upon reference to the Drawings, wherein like numerals depict like parts, and wherein:

### BRIEF DESCRIPTION OF THE DRAWINGS

FIG. 1 is a block diagram of an exemplary arbitration system according to the present invention;

FIG. 2 is a flow diagram of an exemplary arbitration process according to the present invention; and

FIG. 3 is a flow diagram of an exemplary bandwidth assignment according to the present invention.

### DETAILED DESCRIPTION OF EXEMPLARY EMBODIMENTS

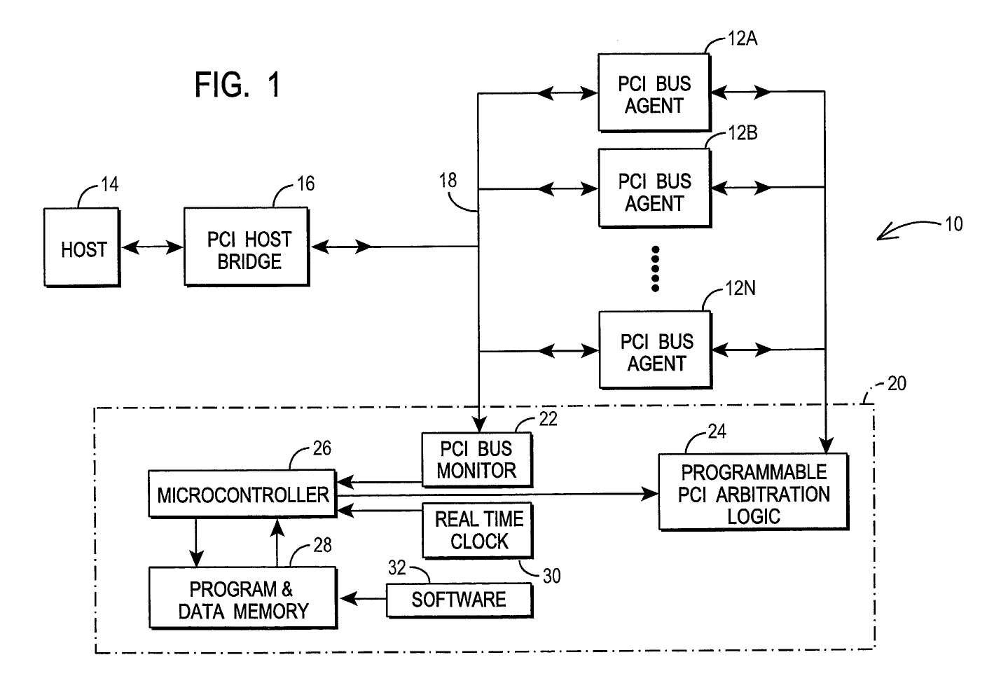

FIG. 1 depicts an exemplary arbitration system 10 according to the present invention. In typical PCI bus systems, PCI Bus Agents (12A, 12B . . . 12n) request usage of the bus 18 and, when granted by an arbiter (not shown), transact data with the Host 14 through the PCI Host Bridge 16 using standard PCI bus protocols. Typical arbiters used in such situations are fairly simple and generally allocate each PCI bus Agent a fixed priority (e.g., even, high, low priority). Such a fixed arbitration scheme is however not likely to provide the optimum PCI bus bandwidth utilization for all transactional situations. In order to optimize PCI bus bandwidth arbitration, priority must be allocated dynamically on a demand basis in an “intelligent” manner as is proposed below.

Broadly defined, the present invention includes an arbitration process that can be summarized as follows. 1) Start with a fixed arbitration, 2) Routinely perform experiments to determine the bandwidth demand for each PCI agent by skewing arbitration priority to the particular PCI agent, 3) Correlate the experimental demands for each PCI agent for durations of 168 hours (i.e.-one week), 4) Apply statistical techniques to the correlated data to remove any aberrations and to determine a mean demand for each PCI agent as a function of time, 5) Assign bus arbitration priority to each PCI agent dynamically over time based on the historical ratio of the PCI agent's demand over the sum of the demands of all PCI agents. The process may also include the step of perpetually repeating the process starting at step 2. In essence the system is, experimenting and over time learning how to best allocate PCI bus bandwidth.

Implementation of the arbitration system 10 is depicted in FIG. 1. In this exemplary embodiment, the system 10 includes an arbitration controller 20 which is adapted with hardware and software (described below) to monitor the PCI bus bandwidth utilization of each agent, calculate an optimal usage of bandwidth for each agent and generate grant control signals to each agent to couple/decouple the agents to and from the bus (i.e., arbitrate) based on the optimal bandwidth usage calculation. “Optimal” as described herein may not necessarily mean the best or most efficient (although, over time, the process according to the present invention may achieve such a result), but rather “optimal” as used herein means a calculation that achieves bandwidth allocation to each agent sufficient to accomplish requested or necessary transactions between the agents and the host.

In the exemplary embodiment, the arbitration controller 20 includes a PCI bus monitor 22 consisting of logic (not shown) which interprets PCI protocol and passively snoops some or all PCI bus transactions. From the data snooped from each PCI bus transaction the logic calculates the effective bandwidth for the transaction and, on a PCI agent basis, stores the running average in bandwidth registers that can be read and cleared by the Microcontroller 26.

The Programmable PCI Arbitration Logic 24 consists of priority assignment registers (not shown) for each PCI bus agent, as well as logic (not shown) to generate grant control signals based on the priority assignment registers. The registers are writeable by the microcontroller 26. In this exemplary system, the logic decodes the priority assignment registers for each PCI bus agent and assigns each agent a number of “turns” (i.e., time which an agent is coupled to the bus to utilize bandwidth) based on the value in its respective priority assignment register. The logic then determines the total number of “turns” by totaling up the priority assignment registers for all PCI bus agents. Having determined the total number of “turns” and the number of “turns” each PCI bus agent gets the logic distributes the “turns” evenly to form an arbitration “loop”. For example if there are only two agents (A and B), with the respective priority assignment registers set to 5 and 4, the A,B,A,B,A,B,A,B,A, . . . (repeat) . . . , A,B,A,B,A,B,A,B,A . . . , ETC. Agent ‘A’ would over time get 5/9ths of the total bandwidth and agent ‘B’ would get 4/9ths of the total bandwidth. A Real Time Clock 30 is readable by and used by the Microcontroller 26 for calculations, correlations, and assignments which are based on real time (e.g., 168 hours).

The Microcontroller 26 including program and data memory 28 uses inputs from the PCI Bus Monitor 22 and Real Time Clock 30 to implement the calculations necessary to manipulate the registers in the Programmable PCI Arbitration Logic 24, in a manner according to the process described more fully below.

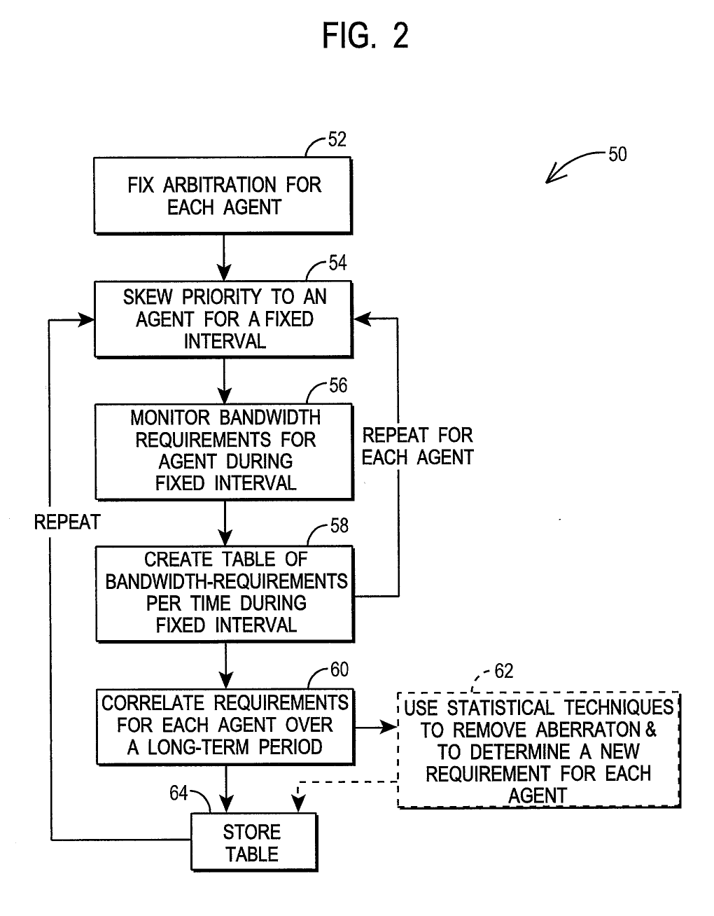

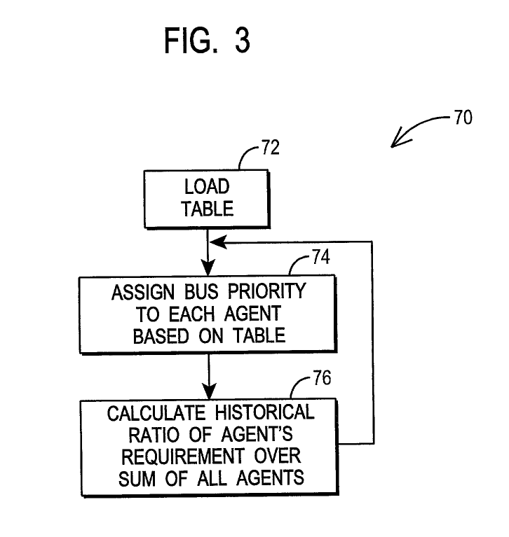

The Software 32 implements an exemplary process 50 and 70 according to the present invention. Referring now to FIGS. 2 and 3, the process starts with a fixed arbitration for each agent 52. This is realized by the Microcontroller writing all priority assignment registers to the same value. For example a value of 0×01 may be chosen by default. In this manner, each agent will get a “turn” at the PCI bus for the same amount of time. The process then continues by routinely perform experiments to determine the bandwidth demand for each PCI agent, for example, by skewing arbitration priority to a particular PCI agent for a fixed (known) interval 54. To accomplish this, the Microcontroller may be adapted to schedule an experiment for each agent sequentially staggered at one minute intervals. When an agent is scheduled, the microcontroller zeros out the priority assignment registers for all agents except the agent under test, clears the bandwidth register for the agent under test, waits for 1 second, monitors the bandwidth register to monitor the bandwidth requirements for the agent under test 56. A table is created which records current bandwidth demand (during the interval under test) for this agent 58, and then restores all agent's priority assignment registers to their prior value.

In the next step, the process correlates the experimental demands for each PCI agent for durations over a long-term period 60, e.g. 168 hours (i.e.-one week). Using the Real Time Clock the Microcontroller correlates the data and maintains a table of current demand versus time for a repeating period of 168 hours. The table is stored 64 for use by the PCI arbitration logic 60 in a manner consistent with the description herein.

The process may also include the step of applying statistical techniques to the correlated data to remove any aberrations and to determine a mean demand for each PCI agent as a function of time 62. Using standard statistical techniques and the tables of current demand versus time the Microcontroller calculates the appropriate means. The calculated means are then stored and maintained as a running average in a table of historic demand versus time for a repeating period of, for example, 168 hours. Referring to FIG. 3, the process 70 continues by loading the table 72 and assigning bus arbitration priority to each PCI agent 74 dynamically over time based on the historical ratio of the PCI agent's demand over the sum of the demands of all PCI agents 76. Using the table of historic demand versus time the Microcontroller may also normalize the demands for each agent and writes the priority demand registers for each agent with values in their respective ratios.

Although the present invention utilizes a specific example of arbitration of a PCI bus bandwidth, it will be readily recognized that the present invention should be construed broadly to any arbitration system and process, for example to any generic communication channel, etc. Those skilled in the art will also recognize numerous modifications which may be made without departing from the present invention. For example, the above-described process assumes a continuous repetition of the process steps to adapt to changes in agent bandwidth requirements. However, the present invention could be modified to a scheduled or random interval to run the process. Also, the present invention may also be modified to cooperate with existing arbitration schemes (e.g., fixed priority) so that agents that require specific bandwidth requirements are given priority in the process, while the process continues in a “background” fashion.

The system and method as described provides a basis for numerous additional enhancements. In general all the time values described previously (e.g.-one minute, one second, 168 hours) are somewhat arbitrary and not necessarily optimal. By providing an overall aggregate average bandwidth register and logic in the PCI Bus Monitor, together with a supplemental layer of Microcontroller experimentation, additional bandwidth optimization is possible. For example, on a very gradual basis the Microcontroller could vary each of the times separately and measure the effect on the overall aggregate average bandwidth and ultimately settle on the best combination.

The overall aggregate average bandwidth can also be used to statistically skew the table of historic demand versus time toward solutions that provide greater overall aggregate bandwidth. Since the table of historic demand is dynamic, the microcontroller could save weekly back issues of the table along with a snapshot of the overall aggregate bandwidth register associated in time with it. Now when calculating the new table of historical results the Microcontroller could consider the back issues and slightly weight the new calculations to the back issues with highest overall aggregate bandwidth.

These and other modifications will become apparent to those skilled in the art, and all such modifications are deemed within the spirit and scope of the present invention as defined by the appended claims.

1. A resource arbitration system, comprising:
a plurality of agents selectively coupled to a resource; and
an arbitration controller adapted to monitor said resource used by each agent and adapted to calculate an optimal usage of said resource for each agent and generate grant control signals to each agent to couple said agents to said resource based on said calculated optimal usage for each said agent.

2. A resource arbitration process comprising the steps of:
fixing an arbitration for a plurality of agents sharing a resource;
determining the demand for each agent by skewing arbitration priority to the particular agent;
correlating the demands for each agent for a predetermined duration; and
assigning resource arbitration priority to each agent based on the historical ratio of the demand for each agent over the sum of the demands of all agents.

3. A resource arbitration process as claimed in claim 2, further comprising the step of applying statistical techniques to the correlated data to determine a mean demand for each agent.

4. A resource arbitration process as claimed in claim 2, further comprising the step of repeating the process of determining the demand, correlating the demands and assigning resource arbitration.

5. A bus arbitration system, comprising:
a plurality of bus agents selectively coupled to a bus; and
an arbitration controller adapted to monitor said bus used by each bus agent and adapted to calculate an optimal usage of said bus for each bus agent and generate grant control signals to each bus agent to couple said bus agents to said bus based on said calculated optimal usage for each said bus agent.

6. A bus arbitration system as claimed in claim 5, wherein said bus is a PCI bus and said bus agents are PCI agents.

7. A bus arbitration system as claimed in claim 5, said arbitration controller comprising a bus monitor consisting of logic which monitors some or all of bus transactions for each said bus agent; and programmable bus arbitration logic comprising priority assignment registers for each bus agent and logic to generate said grant control signals based on the data stored in said priority assignment registers.

8. A bus arbitration system as claimed in claim 7, wherein said bus monitor calculates the bus effective bandwidth for each transaction of each said bus agent, and stores the running average for each bus agent in bandwidth registers.

9. A bus arbitration system as claimed in claim 7, wherein said programmable bus arbitration logic decodes said priority assignment registers for each bus agent and assigns each agent a number of grant control signals based on the value in its respective priority assignment register.

10. A resource arbitration process comprising the steps of:
fixing an arbitration of each agent sharing a resource;
skewing priority to an agent for a fixed interval;
monitoring resource usage of said agent having priority;
creating a table of resource requirements for each agent during said fixed interval; and
assigning resource priority to each agent based on said table of resource requirements.

11. A resource arbitration process as claimed in claim 10, further comprising the steps of:
correlating resource requirements for each agent over a specified period of time; and
statistically removing aberrations from said data and determining a mean resource requirement for each agent.
